(19) United States
(12) Patent Application Publication
(10) Pub. No.: US 2026/0058344 A1
(43) Pub. Date: Feb. 26, 2026

(54) TRACTION BATTERY PACK PORT ASSEMBLY

(71) Applicant: Ford Global Technologies, LLC, Dearborn, MI (US)

(72) Inventors: Samuel Jeffrey Tomlinson, Farmington Hills, MI (US); Robert Harless Kalinski, Royal Oak, MI (US)

(21) Appl. No.: 18/814,189

(22) Filed: Aug. 23, 2024

(51) Int. Cl. H01M 50/627; H01M 50/262; H01M 50/682; H01M 50/691

(52) U.S. Cl. CPC H01M 50/627; H01M 50/262; H01M 50/682; H01M 50/691

(57) ABSTRACT

A traction battery pack port assembly includes a header that is securable to an enclosure. The header has an inner spigot that is connectable to a battery pack conduit at a position inside the enclosure; and an outer spigot secured to the header. The outer spigot can be removably secured to the header, and the outer spigot can be removed without needed access to the inside of the enclosure. Removing the outer spigot may be needed when servicing the port assembly.

### TECHNICAL FIELD

This disclosure relates generally to a port assembly of a traction battery pack and, more particularly, to a port assembly having a spigot that can be serviced from outside an enclosure of the battery pack.

### BACKGROUND

Electrified vehicles differ from conventional motor vehicles because electrified vehicles can be selectively driven by one or more electric machines that are powered by a traction battery pack. The electric machines can propel the electrified vehicles instead of, or in combination with, an internal combustion engine. Various fluids, such as coolants and lubricants, can communicate to and from the traction battery pack.

### SUMMARY

In some aspects, the techniques described herein relate to a traction battery pack port assembly, including: a header that is securable to an enclosure, the header having an inner spigot that is connectable to a battery pack conduit at a position inside the enclosure; and an outer spigot secured to the header.

In some aspects, the techniques described herein relate to a traction battery pack port assembly, wherein the outer spigot is secured to the header with a twist-lock.

In some aspects, the techniques described herein relate to a traction battery pack port assembly, wherein the outer spigot is secured to the header with a cam-lock.

In some aspects, the techniques described herein relate to a traction battery pack port assembly, wherein the outer spigot is removably secured to the header.

In some aspects, the techniques described herein relate to a traction battery pack port assembly, further including an O-ring seal that seals interface between the outer spigot and the header when the outer spigot is secured to the header.

In some aspects, the techniques described herein relate to a traction battery pack port assembly, wherein the outer spigot and the inner spigot are fluidly connected when the outer spigot is secured to the header.

In some aspects, the techniques described herein relate to a traction battery pack port assembly, wherein the header is securable to the enclosure such that the header is adjacent an outer surface of the enclosure.

In some aspects, the techniques described herein relate to a traction battery pack port assembly, wherein the header and the inner spigot are formed together as a single structure.

In some aspects, the techniques described herein relate to a traction battery pack port assembly, further including a plurality of mechanical fasteners that extend through the enclosure to secure the header to the enclosure.

In some aspects, the techniques described herein relate to a traction battery pack port assembly, wherein the inner spigot extends from a position outside the enclosure to a position inside the enclosure when the header is secured to the enclosure.

In some aspects, the techniques described herein relate to a traction battery pack port assembly, wherein the inner spigot, the header, and the outer spigot are a polymer-based material.

In some aspects, the techniques described herein relate to a traction battery pack port assembly, wherein the outer spigot includes a stress focusing feature.

In some aspects, the techniques described herein relate to a traction battery pack port assembly, wherein the stress focusing feature is an annular groove.

In some aspects, the techniques described herein relate to a traction battery pack port assembly, wherein, when the outer spigot is secured to the header, the inner spigot and the outer spigot provide a liquid communication path extending between an interior of the enclosure and an exterior of the enclosure.

In some aspects, the techniques described herein relate to a traction battery pack port providing method, including: securing a header to an enclosure such that an inner spigot is connectable to a battery pack conduit at a position inside the enclosure; and securing an outer spigot to the header.

In some aspects, the techniques described herein relate to a method, wherein the outer spigot is removably secured to the header from outside the enclosure.

In some aspects, the techniques described herein relate to a method, further including using a twist-lock to secure the outer spigot to the header.

In some aspects, the techniques described herein relate to a method, wherein the inner spigot extends from outside the enclosure to inside the enclosure.

In some aspects, the techniques described herein relate to a method, further including securing the header to the enclosure using a plurality of mechanical fasteners that extend through the enclosure.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a side view of an electrified vehicle.

FIG. 2 illustrates an expanded, perspective view of a battery pack from the electrified vehicle of FIG. 1.

FIG. 3 illustrates a section view through a portion of the battery pack in FIG. 2 showing a port assembly.

FIG. 4 illustrates close-up, perspective view of a portion of an outer spigot from the port assembly of FIG. 3.

FIG. 5 illustrates a close-up, perspective view of a portion of the header from the port assembly of FIG. 3.

### DETAILED DESCRIPTION

This disclosure details exemplary port assemblies and port providing methods for a traction battery pack. The port assemblies can mount to an enclosure of the traction battery pack. the port assemblies can each provide a passage through the enclosure to an interior of the traction battery pack. The passage can be used to communicate a fluid to or from the interior. Selected portions of the port assemblies can be detached from outside the traction battery pack enclosure. This can facilitate servicing the port assemblies.

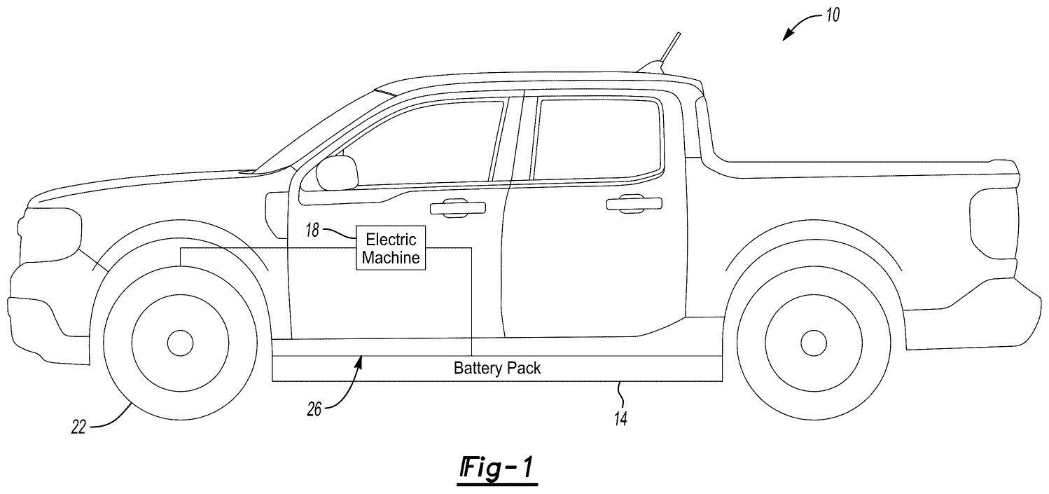

With reference to FIG. 1, an electrified vehicle 10 includes a battery pack 14, an electric machine 18, and wheels 22. The battery pack 14 powers an electric machine 18, which can convert electrical power to mechanical power to drive the wheels 22. The battery pack 14 is thus a traction battery pack.

The battery pack 14 is, in the exemplary embodiment, secured to an underbody 26 of the electrified vehicle 10. The battery pack 14 could be located elsewhere on the electrified vehicle 10 in other examples.

The electrified vehicle 10 is an all-electric vehicle. In other examples, the electrified vehicle 10 is a hybrid electric vehicle, which selectively drives wheels using torque provided by an internal combustion engine instead of, or in addition to, an electric machine. Generally, the electrified vehicle 10 could be any type of vehicle having a battery pack.

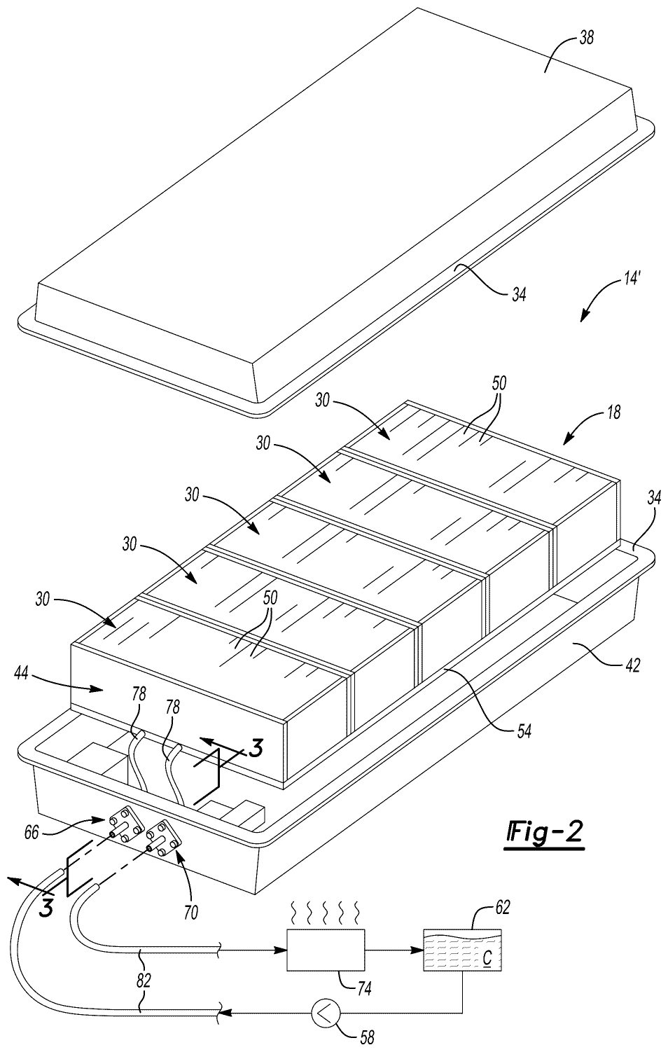

With reference now to FIG. 2, the battery pack 14 includes a plurality of battery arrays 30 held within an enclosure assembly 34. In the exemplary embodiment, the enclosure assembly 34 includes an enclosure cover 38 and an enclosure tray 42. The enclosure cover 38 can be secured to the enclosure tray 42 to provide an interior 44 that houses the battery arrays 30. The enclosure cover 38 can be secured to the enclosure tray 42 using mechanical fasteners (not shown), for example.

Each of the battery arrays 30 includes, among other things, a plurality of battery cells 50 (or simply “cells”) stacked side-by-side relative to each along a respective battery array axis. The battery cells 50 store and supply electrical power. Although a specific number of the battery arrays 30 and cells 50 are illustrated in the various figures of this disclosure, the battery pack 14 could include any number of the battery arrays 30 each having any number of individual cells 50.

In an embodiment, the battery cells 50 are lithium-ion pouch-style cells. However, battery cells having other geometries (cylindrical, prismatic, etc.), other chemistries (nickel metal hydride, lead acid, etc.), or both could be alternatively utilized within the scope of this disclosure.

The battery cells 50 can be disposed upon a thermal exchange plate 54. A coolant can be circulated through the thermal exchange plate 54 to manage thermal energy within the battery cells 50 and other portions of the traction battery pack 14.

In this example, a pump 58 circulates coolant C from a coolant supply 62 through a first port assembly 66 to the interior 44 from a position outside the enclosure assembly 34. After taking on thermal energy within the interior 44, the coolant moves through a second port assembly 70 outside the enclosure assembly 34 to a thermal exchange device 74, such as a radiator. The coolant releases thermal energy at the thermal exchange device 74. The coolant then is then returned to the coolant supply 62. The first port assembly 66 and the second port assembly 70 thus, in this example, act as interfaces for communicating liquid coolant to and from the interior of the enclosure assembly 34. The first port assembly 66 and the second port assembly 70 could communicate other liquids in other examples, such as a lubricant.

The battery pack 14 includes battery pack conduits 78 within the interior. One of the battery pack conduits 78 can connect the first port assembly 66 to the thermal exchange plate 54. Another of the battery pack conduits 78 can connect the second port assembly 70 to the thermal exchange plate 54.

Outside the enclosure of the battery pack 14, external conduits 82 can connect pump 58 to the first port assembly 66, and the second port assembly 70 to the thermal exchange device 74.

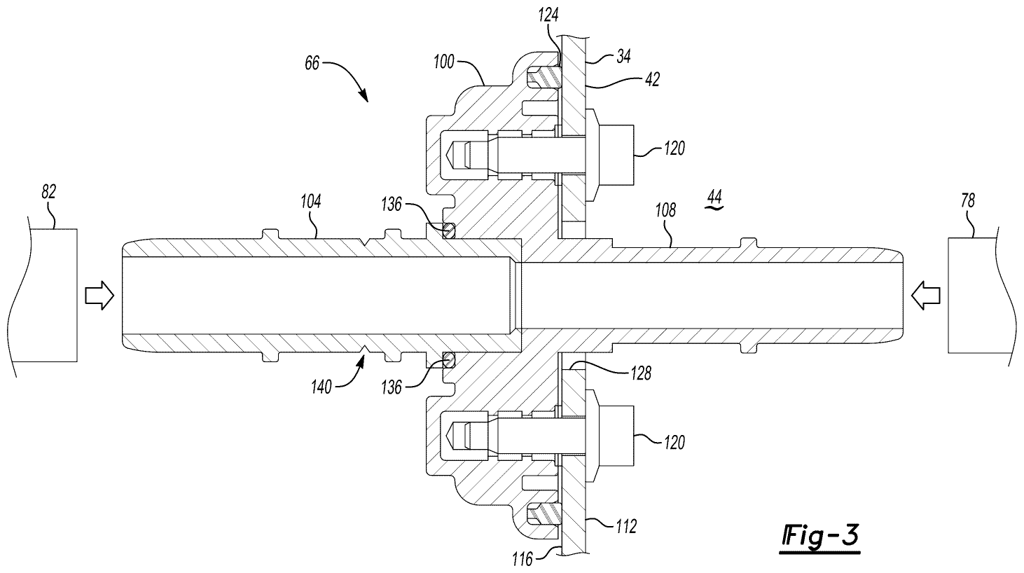

With reference now to FIGS. 3, the first port assembly 66 includes, in this example, a header 100 and an outer spigot 104. The header 100 includes an inner spigot 108. In this example, the inner spigot 108 is part of the header 100 and is formed together with the other portions of the header 100 as a single structure. In another example, the inner spigot 108 is a separate part from the other portions of the header 100.

The example header 100 and the outer spigot 104 are a polymer-based material.

The outer spigot 104 is removably secured, in this example, to the header 100 in a position where the outer spigot 104 is concentric with the inner spigot 108. Fluid, here coolant, can pass through the outer spigot 104 and the inner spigot 108 of the header 100 when communicating with the interior of the enclosure assembly 34. When the outer spigot 104 is secured to the header 100, the inner spigot 108 and the outer spigot 104 provide a liquid communication path extending between the interior 44 of the enclosure assembly 34 and the exterior of the enclosure assembly 34.

The enclosure assembly 34, here the enclosure tray 42, has an inner surface 112 that faces the interior 44 of the enclosure assembly 34 and an outer surface 116 that faces away from the interior 44 of the enclosure assembly 34. The header 100 is secured directly adjacent to the outer surface 116 utilizing a plurality of mechanical fasteners 120 that extend from the interior 44 through the enclosure tray 42. Tightening the fasteners 120 draws the header 100 against the outer surface 116.

The first port assembly 66, in this example, has a header seal 124 that seals an interface between the header 100 and the outer surface 116 when the fasteners 120 draw the header 100 against the outer surface 116. The header seal 124 can reduce leak paths into the interior 44 and help to reduce corrosion. In this example, the fasteners 120 can be tightened from the interior 44 of the enclosure assembly 34 and can threadably engage bores within the header 100.

When the header 100 is secured to the enclosure assembly 34, the inner spigot 108 extends through an aperture 128 in the enclosure tray 42. The inner spigot 108 extends from, in this example, a position that is outside the interior 44 of the enclosure assembly 34 to a position that is inside the interior 44 where the inner spigot 108 can be connected to the battery pack conduit 78, which fluidly couples the first port assembly 66 to the thermal exchange plate 54.

After securing the header 100 to the enclosure tray 42, the outer spigot 104 can be secured to the header 100 from outside the interior 44. The outer spigot 104 is removably secured meaning that the outer spigot 104 can be removed and secured to the header 100 again. Another replacement spigot could also be secured to the header 100 if needed.

In this example, an outer spigot seal 136 is compressed between the outer spigot 104 and the header 100 when the outer spigot seal is secured to the header. The outer spigot seal 136 seals an interface between the outer spigot 104 and the header 100. The outer spigot seal 136 is an O-ring seal in this example.

The method of connecting the outer spigot 104 to the header 100 is a method of removably connecting the outer spigot 104 to the header 100. In this example, reversing the direction of turning the outer spigot 104 can help to disengage the outer spigot 104 from the header 100. This engaging the outer spigot 104 from the header 100 may be required when servicing the first port assembly 66.

The example outer spigot 104 includes a stress focusing feature 140. Should a load be applied to the outer spigot 104 that is sufficient to fracture the outer spigot 104, the fracture tends to occur at the position of the stress focusing feature 140. Such loads could potentially be applied to the outer spigot 104 during shipping or assembly. Since the fracture occurs at this position, there is a portion of the outer spigot 104 that protrudes from the header 100 and can be gripped and turned to disengage that portion from the header 100. A replacement outer spigot can then be engaged with the header 100 without requiring access to the interior 44 of the battery pack 14. Replacing the entire first port assembly 66 is then not required.

The stress focusing feature 140 is an annular groove in this example. The annular groove has a V-shaped cross-section.

When the outer spigot 104 is secured to the header 100, the external conduit 82 can be coupled to the outer spigot 104 to fluidly connect the thermal exchange device 74 to the first port assembly 66.

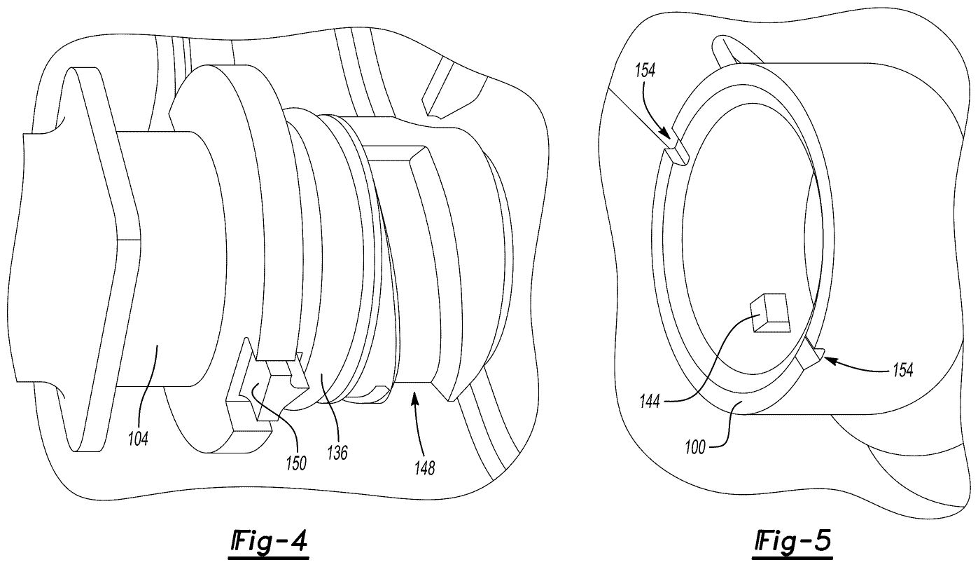

With reference to FIGS. 4 and 5, the outer spigot 104 is secured utilizing a twist-lock connection in this example. The outer spigot 104 can be rotated about its longitudinal axis to move a locking feature 144 in one of the header 100 or the outer spigot 104 into slots 148 in the other of the header 100 or the outer spigot 104. The locking feature 144 and movement within the slot 148 draws the outer spigot 104 toward the header 100 and can compress the outer spigot seal 136. The outer spigot 104 can be rotated and drawn toward the header 100 until lock tabs 150 fit within grooves 154. During ordinary operation of the vehicle 10 and battery pack 14, rotation of the outer spigot 104 is blocked due to the lock tabs 150 within the grooves 154. If servicing the first port assembly 66 is required, sufficient rotational force can overcome the blocking provided by the lock tabs 150 so that the outer spigot 104 can be removed from the header 100.

While shown as a twist-lock, the outer spigot 104 could, in another example, be secured with a cam-lock connection or another type of removable connection.

The fluid communicated through the first port assembly 66 and the second port assembly 70 is coolant that is circulated through the thermal exchange device 74. In other examples, another liquid could communicate through the first port assembly 66 or the second port assembly 70. For example, the liquid could be a dielectric coolant that is used as part of an immersion cooling system for the battery pack 14.

Features of some of the disclosed examples include an outer spigot that can be serviced from outside an enclosure of a battery pack.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A traction battery pack port assembly, comprising:
a header that is securable to an enclosure, the header having an inner spigot that is connectable to a battery pack conduit at a position inside the enclosure; and
an outer spigot secured to the header.

2. The traction battery pack port assembly of claim 1, wherein the outer spigot is secured to the header with a twist-lock.

3. The traction battery pack port assembly of claim 1, wherein the outer spigot is secured to the header with a cam-lock.

4. The traction battery pack port assembly of claim 1, wherein the outer spigot is removably secured to the header.

5. The traction battery pack port assembly of claim 1, further comprising an O-ring seal that seals interface between the outer spigot and the header when the outer spigot is secured to the header.

6. The traction battery pack port assembly of claim 1, wherein the outer spigot and the inner spigot are fluidly connected when the outer spigot is secured to the header.

7. The traction battery pack port assembly of claim 1, wherein the header is securable to the enclosure such that the header is adjacent an outer surface of the enclosure.

8. The traction battery pack port assembly of claim 1, wherein the header and the inner spigot are formed together as a single structure.

9. The traction battery pack port assembly of claim 1, further comprising a plurality of mechanical fasteners that extend through the enclosure to secure the header to the enclosure.

10. The traction battery pack port assembly of claim 1, wherein the inner spigot extends from a position outside the enclosure to a position inside the enclosure when the header is secured to the enclosure.

11. The traction battery pack port assembly of claim 1, wherein the inner spigot, the header, and the outer spigot are a polymer-based material.

12. The traction battery pack port assembly of claim 1, wherein the outer spigot includes a stress focusing feature.

13. The traction battery pack port assembly of claim 12, wherein the stress focusing feature is an annular groove.

14. The traction battery pack port assembly of claim 1, wherein, when the outer spigot is secured to the header, the inner spigot and the outer spigot provide a liquid communication path extending between an interior of the enclosure and an exterior of the enclosure.

15. A traction battery pack port providing method, comprising:
securing a header to an enclosure such that an inner spigot is connectable to a battery pack conduit at a position inside the enclosure; and
securing an outer spigot to the header.

16. The method of claim 15, wherein the outer spigot is removably secured to the header from outside the enclosure.

17. The method of claim 15, further comprising using a twist-lock to secure the outer spigot to the header.

18. The method of claim 15, wherein the inner spigot extends from outside the enclosure to inside the enclosure.

19. The method of claim 15, further comprising securing the header to the enclosure using a plurality of mechanical fasteners that extend through the enclosure.
